(19) United States
(12) Patent Application Publication
(10) Pub. No.: US 2007/0261791 A1
(43) Pub. Date: Nov. 15, 2007

(54) Method for low-cost, practical fabrication of two-dimensional fiber optic bundles

(76) Inventors: Akis Goutzoulis, Annapolis, MD (US); Michael R. Lucas, Ellicott City, MD (US)

Correspondence Address: ANDREWS KURTH LLP;Intellectual Property Department, Suite 1100, 1350 I Street, N.W., Washington, DC, 20005, US

(21) Appl. No.: 11/432,437

(22) Filed: May 12, 2006

(51) Int. Cl. C09J 163/00

(52) U.S. Cl. 156/330

(57) ABSTRACT

A method of low cost, practical fabrication of 2D fiber optic bundles. The method includes stripping an end of a fiber ribbon. The stripping exposes a plurality of stripped fiber ribbon ends. The method also includes etching the stripped fiber ribbon ends and inserting the etched, stripped fiber ribbon ends into a plate. The etching reduces the diameter of stripped fiber ribbon ends. The inserting inserts all of the etched, stripped fiber ribbon ends of the fiber ribbon into the plate simultaneously. The method also includes epoxying the plate and the inserted fiber ribbon ends. The inserted fiber ribbon ends and the plate form a fiber bundle. The fiber bundle is polished.

### BACKGROUND

Coupling of optical signals between multi-Tera-bit-per-seconds (Tbps) and other optically-interconnected boards for next generation processing systems is of critical interest. Metal interconnections (e.g., metal backplanes) appear to reach speed limits which are estimated to be in the 100s of giga-bit-per-second (Gbps) per backplane. In some processing systems, discrete channel fiber optical connections are being incorporated on top of the metal interconnections, but they too are limited to approximately 10 Gbps.

To solve these problems, multiple two-dimensional (2D) parallel optical interconnects have been proposed in connection with optical backplanes. These multiple 2D optical channels may use low cost vertical cavity surface emitting lasers (VCSEL) arrays for transmission and low cost GaAs photodiode arrays for detection (DETECTOR arrays). The VCSEL and DETECTOR arrays may be interconnected via 2D fiberoptic bundles that employ multiple commercial off-the-shelf (COTS) fibers. By paralleling tens-to-hundreds of optical channels, each with independent data, we can increase the backplane data rate dramatically. The greater the number of channels, the greater the overall throughput. Throughput rates exceeding 100 Tbps are envisioned.

Unfortunately, no one has solved the problem of providing practical, low-cost fabrication of 2D fiber optic bundles which will allow massive parallel interconnects between boards and optical backplanes. Virtually all techniques use individual, flat-terminated fibers to fill a 2D pre-drilled metal plate which is then glued and polished. The use of such fibers results in large amounts of broken fibers which require manual labor for replacement and repair.

### SUMMARY

An advantage of the embodiments described herein is that they overcome the disadvantages of the prior art. Another advantage of certain embodiments is they provide a practical, low cost fabrication technique of 2D fiber optic bundles.

These advantages and others are also achieved by a method of low cost, practical fabrication of 2D fiber optic bundles. The method includes stripping an end of a fiber ribbon. The stripping exposes a plurality of stripped fiber ribbon ends. The method also includes etching the stripped fiber ribbon ends and inserting the etched, stripped fiber ribbon ends into a plate. The etching reduces the diameter of stripped fiber ribbon ends. The inserting inserts all of the etched, stripped fiber ribbon ends of the fiber ribbon into the plate simultaneously. The method also includes epoxying the plate and the inserted fiber ribbon ends. The inserted fiber ribbon ends and the plate form a fiber bundle. The fiber bundle is polished.

### DESCRIPTION OF THE DRAWINGS

The detailed description will refer to the following drawings, wherein like numerals refer to like elements, and wherein:

FIG. 1 illustrates components of an embodiment of fiber optic bundle assembly.

FIG. 2 illustrates an embodiment of method for low cost, practical fabrication of 2D fiber optic bundles.

FIG. 3A illustrates a portion of an embodiment of a pre-drilled plate used in fiber optic bundle assembly.

FIG. 3B illustrates a portion of an embodiment of a pre-drilled plate used in fiber optic bundle assembly.

### DETAILED DESCRIPTION

A method of low cost, practical fabrication of two-dimensional (2D) fiber optic bundles is described. Embodiments of the method provide a practical, low cost fabrication technique of 2D fiber optic bundles. Embodiments of the method employ laser pre-drilled or etched 2D arrays of holes on thin metal or ceramic plates, multi-mode fiber ribbon arrays with conical fiber ends (achieved, e.g., via acid etching), and standard epoxy and polishing techniques. The use of 2D fiber arrays provides a very large fiber count thereby dramatically increasing the overall data capacity.

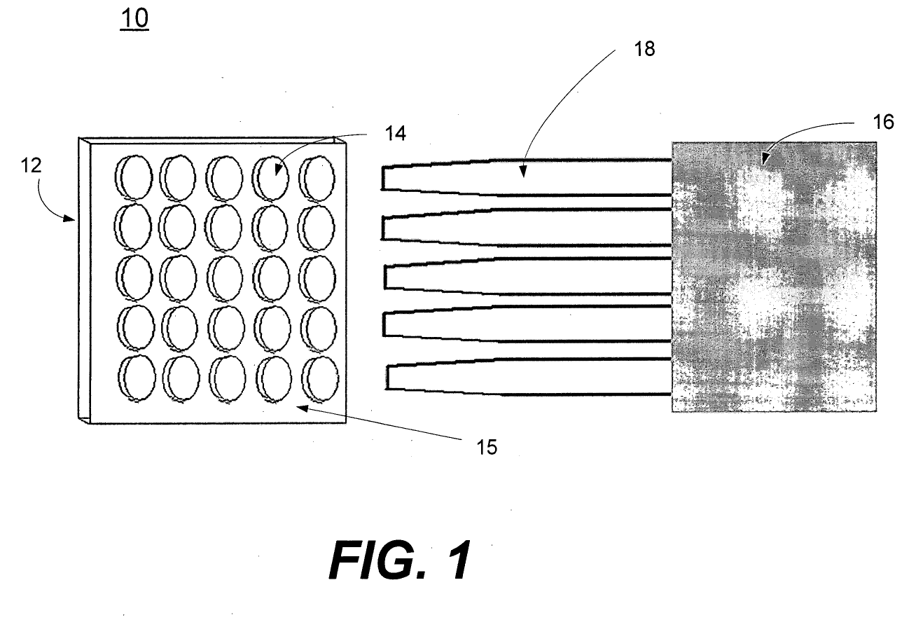

With reference now to FIG. 1, shown is a schematic illustrating exemplary components of a low-cost fiber optic bundle assembly 10 fabricated using embodiments of the method described herein. Low cost fiber optic bundle assembly 10 includes plate 12 drilled with a plurality of holes 14 and multiple fiber ribbons 16 with etched-stripped fiber ribbon ends 18. Fiber ribbon 16 may comprise, for example, single or multimode fibers or graded index fibers, with, e.g., single or double cladding. Holes 14 are arranged in hole grid 15 that is equal to the grid of the etched-stripped fiber ribbon ends 18. In other words, etched-stripped fiber ribbon ends 18 should match the hole grid 15 in arrangement, alignment, number and spacing. Such matching may require multiple fiber ribbons 16 in order to have enough stripped fiber ribbon ends 18 to fill hole grid 15.

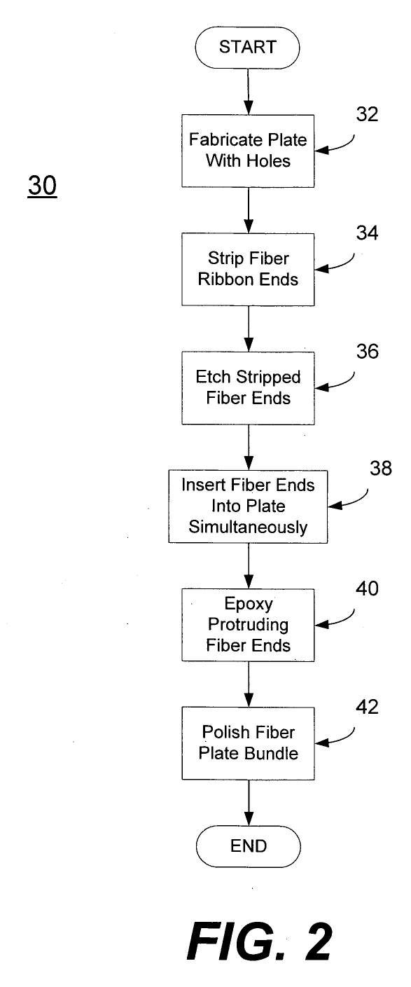

With reference now to FIG. 2, shown is a flowchart illustrating an embodiment of method 30 for low cost, practical fabrication of two-dimensional (2D) fiber optic bundles. Method 30 fabricates a drilled metal or ceramic plate with a hole grid (block 32). Hole grid is preferably fabricated 32 to be equal to grid of fiber of a fiber ribbon cable to be used in the assembly. Likewise, the diameter of the holes in hole grid is preferably equal to the fiber diameter, which, depending on the type of the bundle used, may be equal to the fiber cladding diameter or to the fiber buffer diameter. Method 30 strips the fiber ribbon ends (block 34). In an embodiment, the fiber ribbon ends are stripped 34 to expose 2-3 cm of fiber ribbon ends. The stripping 34 may be done one ribbon at a time.

Method 30 etches the stripped fiber ends (block 36). In an embodiment, the stripped fiber ends are all etched 36 in parallel. The etching 36 may produce tapered ends that more easily insert into the fabricated plate. Method 30 inserts the full etched-stripped fiber ribbon ends into the fabricated plate (block 38). The fiber ribbons are preferably inserted one entire fiber ribbon at a time (i.e., stripped fiber ribbon ends from one fiber ribbon are inserted simultaneously), as opposed to prior art methods that insert a single fiber at a time. Method 30 epoxies the inserted fiber ribbon ends that extend through the plate (block 40). The bundle end, i.e., the epoxied plate and fiber ribbon ends, is polished (block 42).

With continuing reference to FIG. 2, an exemplary fabrication 32 of pre-drilled plate 12 is discussed in greater detail. Pre-drilled plate 12 may be drilled in a variety of manners. For example, plate 12 drilling may be accomplished using laser drilling or chemical etching techniques. Laser drilling is especially adaptable for small holes 14 with large depth-to-diameter ratios, such as are needed for relatively thick (e.g., ˜1 mm) metal plates. Laser drilling is a process that includes repeatedly pulsing focused laser energy at a material and vaporizing some of the material, until a through-hole is created in the material. Depending on the material used and the material thickness, a hole 14 could be as small as 25 microns (μm) in diameter. Such size holes 14 would enable pre-drilled plate 12 to accommodate very skinny fibers.

To facilitate the entry of a full-stripped fiber ribbon end, holes 14 are preferably conical. Conical holes 14 may be accomplished if the laser, once through the material, is moved with respect to plate 12 to contour the hole 14 to the desired diameter. Such a procedure is called “trepanning.” The end result is a fast, efficient way to create conical holes 14.

With laser drilling, a wide range of hole 14 diameters is possible. Likewise, many different materials, such as steel, nickel alloys, aluminum, borosilicate glass, quartz, and ceramics may be drilled with a laser drill. A laser drill is so fast and repeatable that it is particularly ideal for high production volumes associated with fully automated or semi-automated tooling applications.

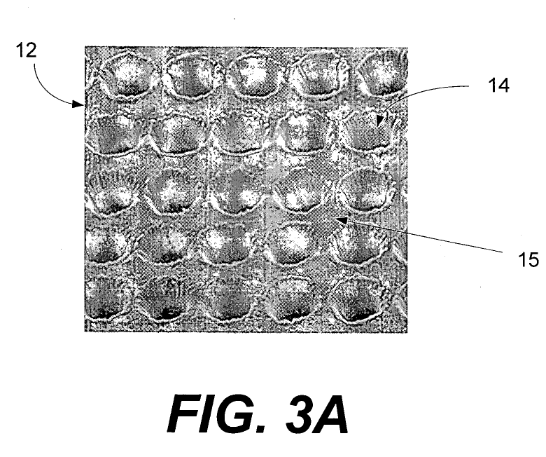

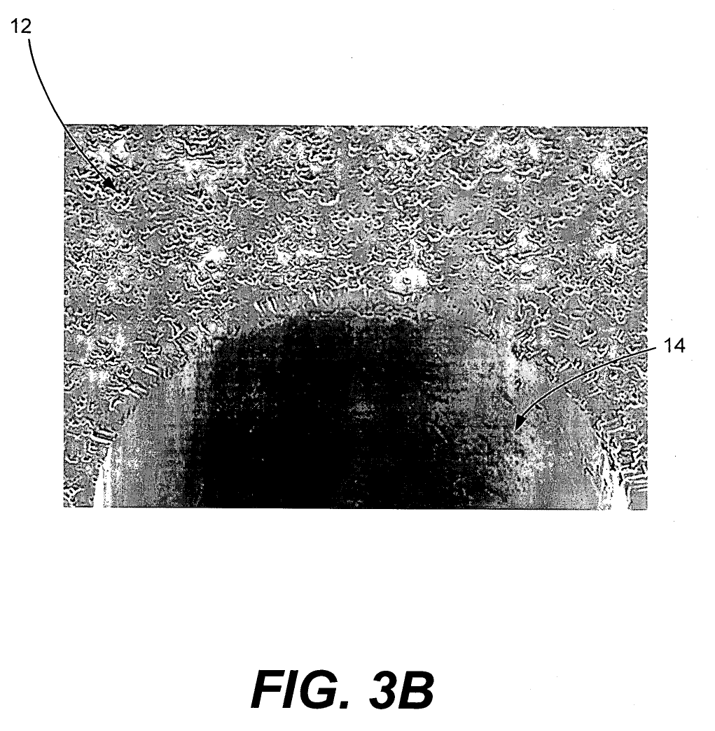

With reference now to FIG. 3A, shown is a COTS metal plate 12 with laser drilled conical holes 14 of 25 μm diameter. Post drilling cleanup with acid etching removes slag and leaves smooth holes. With reference now to FIG. 3B, shown is a partial view of a 200 μm diameter hole 14 in a ceramic plate 12. FIGS. 3A-3B show that commercial laser capability can provide adequate pre-drilled plates 12 for method 20. For example, for a typical multi-mode fiber bundle, hole grid 15 is 250 μm (i.e., spacing between holes 14 in hole grid 15 is 250 μm), the small end of the holes 14 is 125 μm, and the wide end of the holes 14 is 175 μm.

With reference again to FIGS. 1 and 2, an exemplary stripping 34 of fiber ribbon ends 18 is described in more detail. Stripping 34 may be performed using low cost COTS thermal strippers. An end of fiber ribbon 16 is inserted (e.g., through a fiber guide) into a heater oven of the thermal strippers, to a desired strip length (e.g., 2-3 cm). Handles of the thermal strippers are closed and the blades of the thermal strippers, which are precisely aligned for this purpose, concentrically score fiber ribbon 16 without damaging core or cladding of the fiber ribbon 16. The heater oven is automatically activated to start softening process. After about 5-10 seconds, fiber ribbon 16 is pulled from the stripper, with slowly increasing pull force until the ribbon coating releases from the fibers. The result of this process is a 2-3 cm stripped ribbon cable with stripped fiber ribbon ends 18 that maintain their relative spacing, i.e., if the ribbon has a 250 μm fiber-to fiber spacing, the spacing of stripped fiber ribbon ends 18 is also 250 μm (thus, matching hole grid 15). This maintenance of spacing occurs because: (1) a small length (2-3 cm) of fiber ends is stripped, and (2) the thermal stripping process allows buffer coating on the fiber ribbon to maintain its strength. The buffer coating maintains the rigidity, and thus the spacing, of the stripped fiber ribbon ends 18.

With continued reference to FIG. 2, an exemplary etching 36 of stripped fiber ribbon ends 18 is described in more detail. To facilitate entry of stripped fiber ribbon ends 18 into holes 14, the diameter of stripped fiber is reduced at the tips or ends (termination) of stripped fiber ribbon ends 18. One process that works particularly well for controlling the cross-sectional area of a fiber is wet chemical etching by hydrofluoric (HF) acid. Before etching, the stripped portion of stripped fiber ribbon ends 18 are cleaned, e.g., with acetone. Next, fiber ribbon 16 may be mounted vertically in a fixture attached to a micrometer drive such that the fibers can be mechanically lowered into a container (e.g., a beaker) containing concentrated HF acid (e.g., 49% solution). During the HF acid etching process, the stripped, cleaned fiber ribbon ends 18 are preferably lowered 0.5-1 cm below the surface of the HF solution. In an embodiment, the fiber mounting fixture should be designed so that all the fiber ribbons 16 required to fill hole grid 15 (i.e., fill plate 12) may be etched simultaneously (alternatively, stripped fiber ribbon ends 18 may be etched one at a time or in sub-groups). After etching, etched, stripped fiber ribbon ends 18 are thoroughly washed, e.g., in water, to remove all traces of the HF acid.

In a test of etching 36 described above, a fiber ribbon 16 with 50 μm core/125 μm cladding, graded index fiber was used. In order to calibrate the process, a series of measurements was taken of the diameter of the etched fiber as a function of etch time at 5 minute intervals up to 30 minutes. Four fresh fiber samples were etched simultaneously in fresh etchant solution (e.g., HF acid) for each predetermined etch time. The diameters of the four fibers etched simultaneously for a given etch time were found to be the same to within 1% showing that the etching process is very reproducible (similar results were obtained with 9 μm core/125 μm cladding single mode fiber). The average value of the etched fiber diameter measured at each etch time was plotted as a function of etch time. These data showed a linear dependence of fiber diameter on etch time and from the slope of this plot, an etch rate (i.e., rate of decrease of fiber diameter) of 3.4 μm/minute was determined. The diameter of the etched portion of the fiber was found to be uniform over the length of fiber that was immersed in the HF solution with an abrupt transition region ˜300 μm length transition region to the diameter (125 μm) of the un-etched portion of the fiber. This transition region may be made variable, for example, by introducing a buffer solution (e.g., mineral oil) on top of the HF solution during the etching process to control the surface tension at the surface of the fiber in this transition region.

With continued reference again to FIG. 2, an exemplary inserting 38 of etched, stripped fiber ribbon ends 18 into plate 12 is described. In exemplary inserting 38, etched, stripped fiber ribbon ends 18 are inserted into plate 12 one ribbon at a time. In an embodiment, combination of conical plate holes 14 and etched fiber ends greatly facilitates the insertion of a full fiber ribbon 16 end (e.g., 12 or 24 fibers) in a single action or motion. The insertion 38 may be accomplished manually or mechanically. For example, fiber ribbon 16 with stripped fiber ribbon ends 18 may be temporarily attached onto translation stage of device with a conventional manual micrometer drive. In an embodiment, stripped fiber ribbon ends 18 are inserted 38 into plate 12 so that stripped fiber ribbon ends 18 protrude through plate 12 by the full etched amount. Because of the polishing 42, quite significant breakage of protruding fiber ends 18 may be tolerated. Prior to insertion of the next fiber ribbon 16, if more than one fiber ribbon 16 is needed, the already inserted ribbon may be optically examined to verify that possible fiber damage (e.g., breakage, etc.) has occurred to fiber ribbon 16 only on the etched side of plate 12. If damage has occurred to fiber ribbon 16 on the non-etched side, a new fiber ribbon 16 should be inserted.

The exemplary one fiber ribbon 16 at a time insertion process 38 described herein provides dramatic labor savings. Using conventional fiber bundle fabrication techniques, a 24×24 fiber bundle would require the insertion of 576 individual fibers, i.e., such conventional techniques would require 576 insertion steps. The exemplary insertion process 38 described herein would allow the same bundle to be fabricated with only 24 insertion steps, i.e., 24× less insertion time.

With continued reference again to FIG. 2, once all fiber ribbons 16 are inserted, epoxying 40 takes place. An exemplary epoxying 40 is described. A small amount of epoxy is first applied to the back of plate 12. Fiber ribbons 16 are slid firmly into place, if not already, to ensure a good fit. In an embodiment, a hemispherical bead of epoxy is then applied to the front tips of stripped fiber ribbon ends 18 (where the stripped fiber ribbon ends 18 protrude plate 12). The epoxy may then be cured per the manufacturer's instructions.

After curing, a piece of heat shrink tubing may be positioned over fiber ribbons 16 such that fiber ribbons 16 around plate 12 are protected. Heat is then applied until maximum shrinkage of heat shrink tubing occurs.

With reference again to FIG. 2, an exemplary polishing 42 is described in detail. Prior to polishing, excess fibers protruding beyond epoxy beads on face of plate 12 may be cleaved or cut off. A carbide blade may used. Any conventional optical fiber polisher may be used. The plate/ribbon assembly 10 is inserted into an appropriate polishing fixture (e.g., customer made to match overall plate/bundle connector assembly 10). Polishing may be started with a figure-8 pattern. In an embodiment, three polishing size grits (sandpapers) may be used. A typical start would involve 60 μm size grit which is used primarily to remove the epoxy. When a thin film of epoxy is used, 9 μm and 1 μm size grits may be used next successively. Care should be taken so that the polishing tool and the assembly 10 are thoroughly cleaned before using each smaller grit size. Upon completion of polishing 42, assembly 10 is preferably cleaned, dried and inspected.

In sum, the method illustrated in FIG. 2 and described above, provides a cost effective technique of making large 2D arrays of fibers terminated in connectorized ends. This allows use of low cost 2D vertical cavity surface emitting laser (VCSEL) arrays to provide multi-Tbps bandwidth in advanced platforms.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A method of low cost, practical fabrication of 2D fiber optic bundles, comprising:
stripping an end of a fiber ribbon, wherein a plurality of stripped fiber ribbon ends are exposed;
etching the stripped fiber ribbon ends, wherein the etching reduces the diameter of stripped fiber ribbon ends;
inserting the etched, stripped fiber ribbon ends into a plate, wherein the inserting inserts all of the etched, stripped fiber ribbon ends of the fiber ribbon into the plate simultaneously;
epoxying the plate and the inserted fiber ribbon ends, wherein the inserted fiber ribbon ends and the plate form a fiber bundle; and
polishing the fiber bundle.

2. The method of claim 1 further comprising repeating the stripping, etching and inserting for one or more additional fiber ribbons in order to fill the plate.

3. The method of claim 1 further comprising fabricating the plate, wherein the fabricating fabricates a plurality of holes in plate arranged in a hole grid that matches the stripped fiber ribbon ends.

4. The method of claim 3 wherein the fabricating comprises laser drilling the plurality of holes in the plate.

5. The method of claim 3 wherein the fabricating comprises chemical etching a plurality of holes in the plate.

6. The method of claim 3 wherein the fabricating fabricates the plurality of holes as conical holes.

7. The method of claim 1 wherein the plate material is chosen from a list consisting of: steel, nickel alloys, aluminum, borosilicate glass, quartz, or ceramic.

8. The method of claim 1 wherein the stripping is performed using a thermal stripper.

9. The method of claim 1 wherein the etching includes chemical etching.

10. The method of claim 9 wherein the chemical etching is performed using hydrofluoric acid.

11. The method of claim 1 wherein the etching includes:
cleaning the stripped fiber ribbon ends with acetone;
lowering the stripped fiber ribbon ends into a hyrdofluoric acid solution;
maintaining the stripped fiber ribbon ends long enough to achieve the desired etching; and
washing the etched, stripped fiber ribbon ends in water to remove any remaining hydrofluoric acid traces.

12. The method of claim 1 wherein the etching produces tapered stripped fiber ribbon ends.

13. The method of claim 1 wherein the inserting inserts the etched, stripped fiber ribbon ends in a single motion.

14. The method of claim 1 wherein the epoxying applies hemispherical beads of epoxy to tips of etched, stripped fiber ribbon ends extruding from plate.

15. The method of claim 1 wherein the polishing includes:
cleaving excess fibers protruding from the epoxied fiber bundle; and
polishing the epoxied fiber bundle with a plurality of decreasing grit-size sandpaper.

16. The method of claim 1 further comprising applying heat shrink tubing to the epoxied fiber bundle.
